(19) United States
(12) Patent Application Publication
(10) Pub. No.: US 2018/0189401 A1
(43) Pub. Date: Jul. 5, 2018

(54) HEALTHCARE INFORMATION PRESENTATION SYSTEM

(71) Applicant: Steven Alan Gest, Alamo, CA (US)

(72) Inventor: Steven Alan Gest, Alamo, CA (US)

(73) Assignee: Go Health Now, Inc., Alamo, CA (US)

(21) Appl. No.: 15/396,404

(22) Filed: Dec. 30, 2016

(51) Int. Cl. G06F 17/30

(52) U.S. Cl. CPC G06F 17/30867; G06F 17/30312

(57) ABSTRACT

The present invention proposes a system and method of using the system, for presenting health information digital content to a health information consumer, whereby the present invention incorporates an assessment of a health information consumer, physiological data from the health information consumer, and any keyword focus of the health information consumer, with the goal of improving specific content list presented to the health information consumer.

### BACKGROUND

Presently, there are likely at least 500,000 websites and online publications, such as videos, documents, and social media tools disseminating health-related information. Health information consumers access these websites and online publications with the goals of directly obtaining health information, participating in health support groups, and consulting with health professionals.

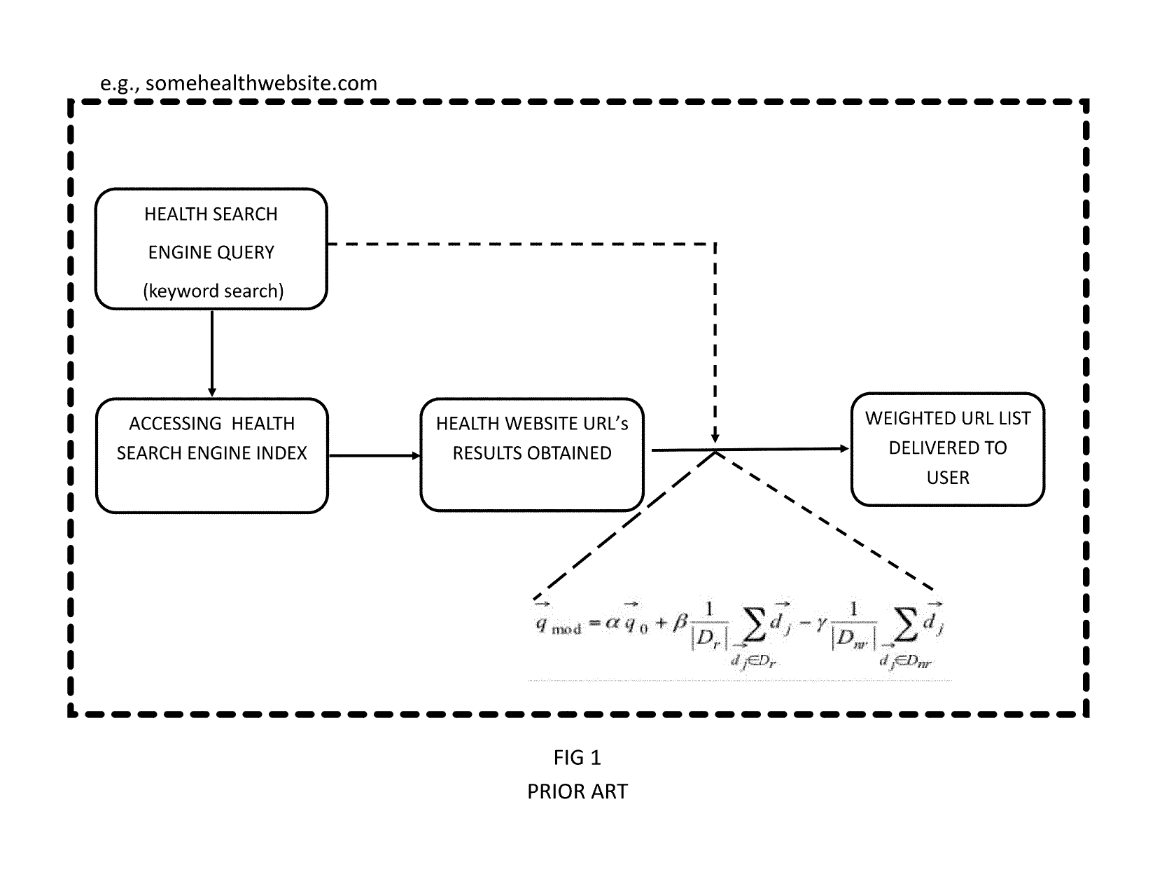

FIG. 1 is an example of the current method of operation for online health information search engines. Such health information search engines are predominantly accessed by non-professionals and consumers. In such a method of operation, a consumer will enter a search query, such as a keyword search, into a search “box” (103). This health query will be used to search an index (105), wherein the index is likely created from crawling throughout the internet and scraping websites and online publications to develop categories. Health information websites and online publications that are pertinent to the search are then obtained (107), following which the listing of health information websites and online publications are subjected to an algorithm (109) which orders the resultant websites and online publications in terms of the most relevant based on the search query keyword being presented higher in the URL list. This weighted URL list is then delivered a user (111), whom may select which websites and online publications to visit on the internet (101). This current method of operation for locating online health information functions in accordance with “web 2.0” protocol for search engine optimization—higher results are presented based upon relation to a keyword query, and each other.

The problem with the state of the art method of health information location is the current method is ineffective because of the number of health-related online resources currently available. With over 500 k health-related online resources, even with a specific search query, a user can expect to receive search results in the tens of thousands. Online health information overload was long recognized as a problem, and this is when the number of online resources numbered 70,000 (“Consumer health information seeking on the Internet: the state of the art”, Cline et al., 2001). The problem of overload is even worse now.

Further, the search results are just that—search results. There are no other factors taken into account that will allow a consumer to determine the most appropriate, most relevant online resources specifically for them. Whereas web 2.0 attempts to structure URL results, disorganization on the Internet is a major problem (Id at Cline et al.) In fact, it is well-known that most consumers limit themselves to the first 2 to 3 pages of search results. Failing to review the 5^{th}, 10^{th}, or 15^{th} page of search results means the consumer may miss locating a valuable online resource that could either provide them the answer they need, or present them valuable alternatives to their health issue.

Lastly, most health information consumers do not perform adequate or suitable searches because of their inability to appropriately describe what they seek in keyword format. Attempts to define very narrow search queries will result in an insufficient number of results.

Presented herein is web 3.0 technology that is not primarily search topic focused. Rather, health information is presented based on demographics, geo-location, self described interests, goals, pre-existing medical conditions, consumption patterns, and common social interests in order to present more relevant, useful, and individual health related information.

It is the goal of the present invention to overcome and improve the existing search technology methods in the industry of digital health related information.

By developing and incorporating such technology, health information resources will be delivered in much smaller numbers, be more specific and relevant to the health information consumer. Through the instant web 3.0 based system, instead of being presented with tens of thousands of search results, a health information consumer will be presented with, for example, a hundred results. As the health information consumer does or does not focus on each delivered result, the proposed system auto-corrects according to their assessed interest in the particular resource.

### DETAILED DESCRIPTION

The present invention proposes a system and a method of using the system, for presenting health information digital content to a health information consumer, whereby the present invention incorporates an assessment of a health information consumer, physiological data from the health information consumer, and any keyword focus of the health information consumer, with the goal of improving specific content list presented to the health information consumer.

Through the present invention, the results of a health information query will be specific to each health information consumer. In other words, under the present invention, for example, two different health information consumers that perform the same health information query will receive different results. The different results are brought about by generated health digital footprint, the digital footprint creating an improvement in the selection of health-related digital content presented to a health-information consumer. The present invention thus allows time saving on behalf of health information consumers by better improving the database content location protocol by only selecting content that is deemed to be specific for a specific health information consumer.

The system of the present invention resides on a server, wherein the server is preferably located at a remote distance from the health information consumer. The server used for the present invention generally includes a memory, a processor, a power source, wherein stored on the memory is a coded application of the present invention. The memory further includes thereon one or more databases and tables stored on the databases, and data stored in the tables, wherein data stored in the tables is modified and organized in such a manner as to improve the selection of content delivered to a health information consumer, in comparison to the prior art. The modification and organization of the data will be discussed in more detail below.

It should be expressly understood that the drawings are included for illustrative purposes and do not represent the scope of the present system. In the accompanying drawings, like reference numbers in different drawings may designate similar elements.

As used herein, the term “health information consumer” and variations thereof refers to an individual, with or through an electronic device or electrical communicative technology access digital health information content or receives guidance and support through a wide area network computer system such as the Internet relating to a health-related issue.

The term “health information content” and variations thereof, including “health information content item” refers to any type of content that exists in the form of digital data and is stored on a server, wherein the content is accessible by a computer system at a remote location from the server through a wide area network computer system such as the Internet.

The terms “health-related”, “health”, and related terms, refers to in humans a state of complete physical, mental, and social well-being and not merely the absence of disease or infirmity.

The term “tuple” refers to finite ordered list of elements.

The term “information” as used herein refers to a digital representation of data or knowledge that is meant to educate or direct a consumer or user of the data or knowledge.

FIG. 1 is an embodiment of the prior art in the industry.

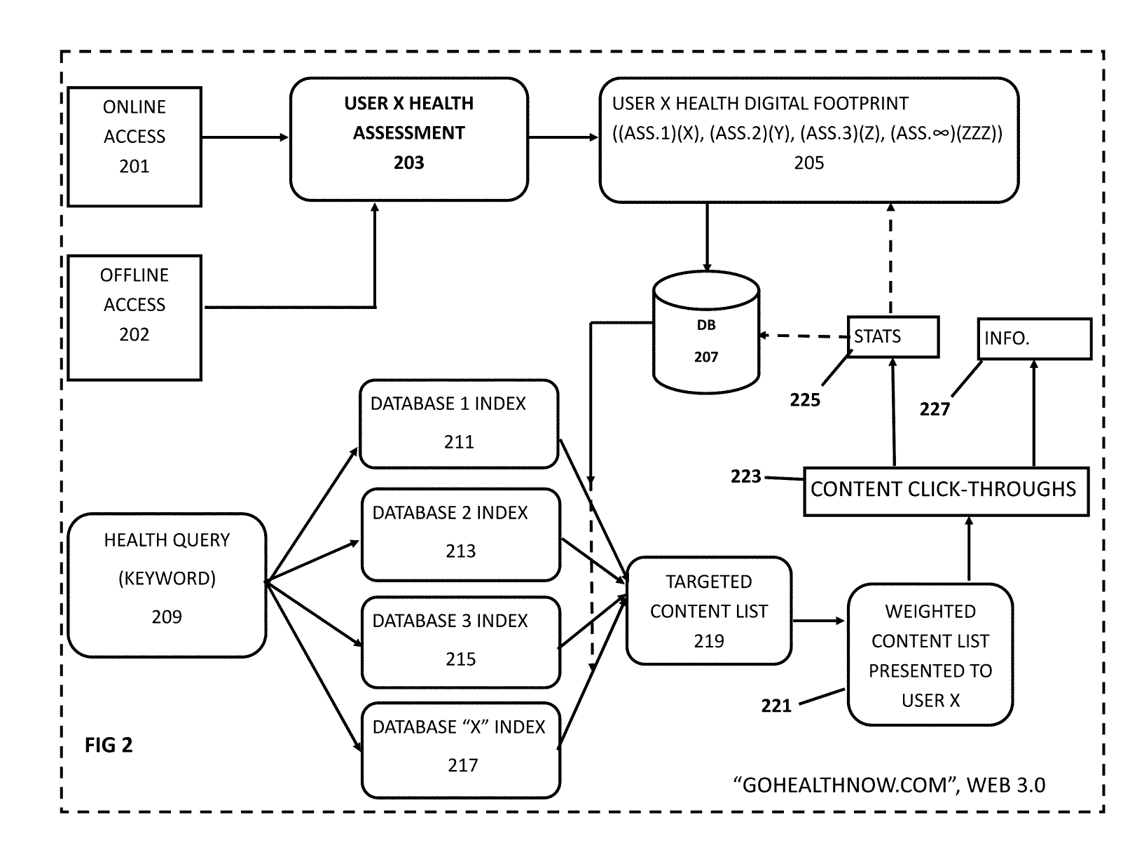

FIG. 2 is an embodiment of the system of the present invention.

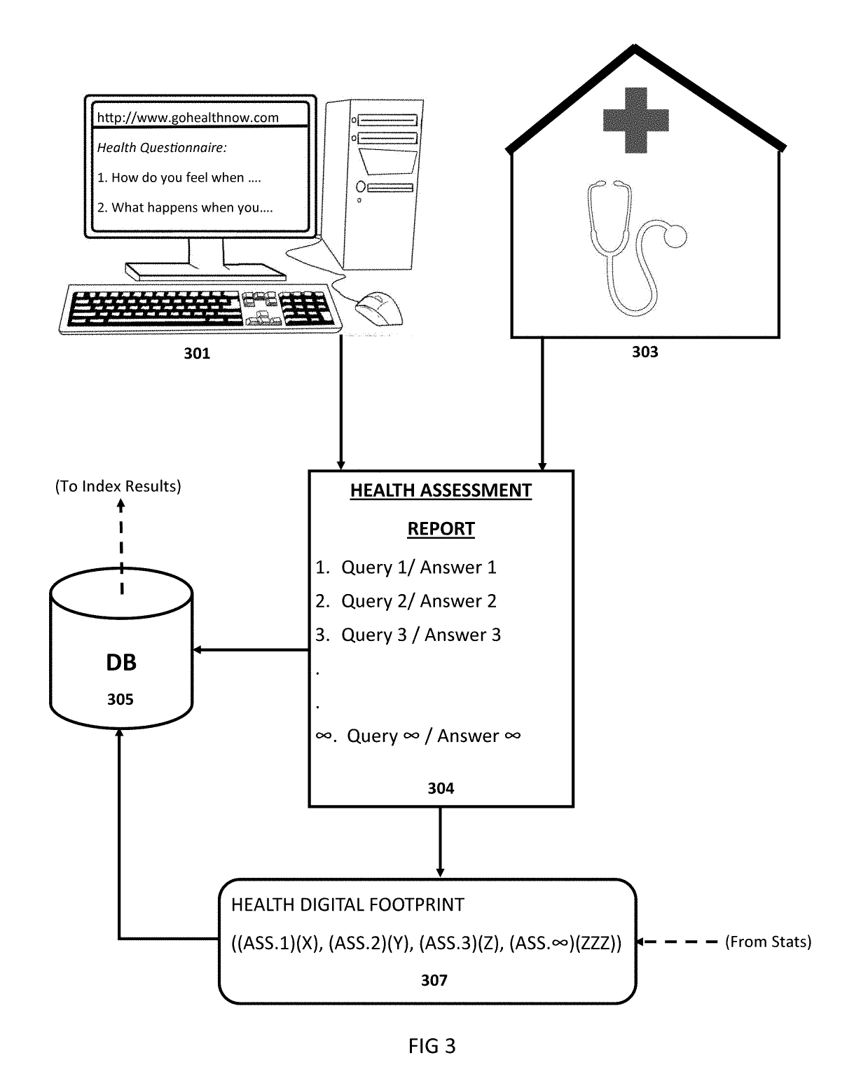

FIG. 3 is an aspect of the system of the present invention.

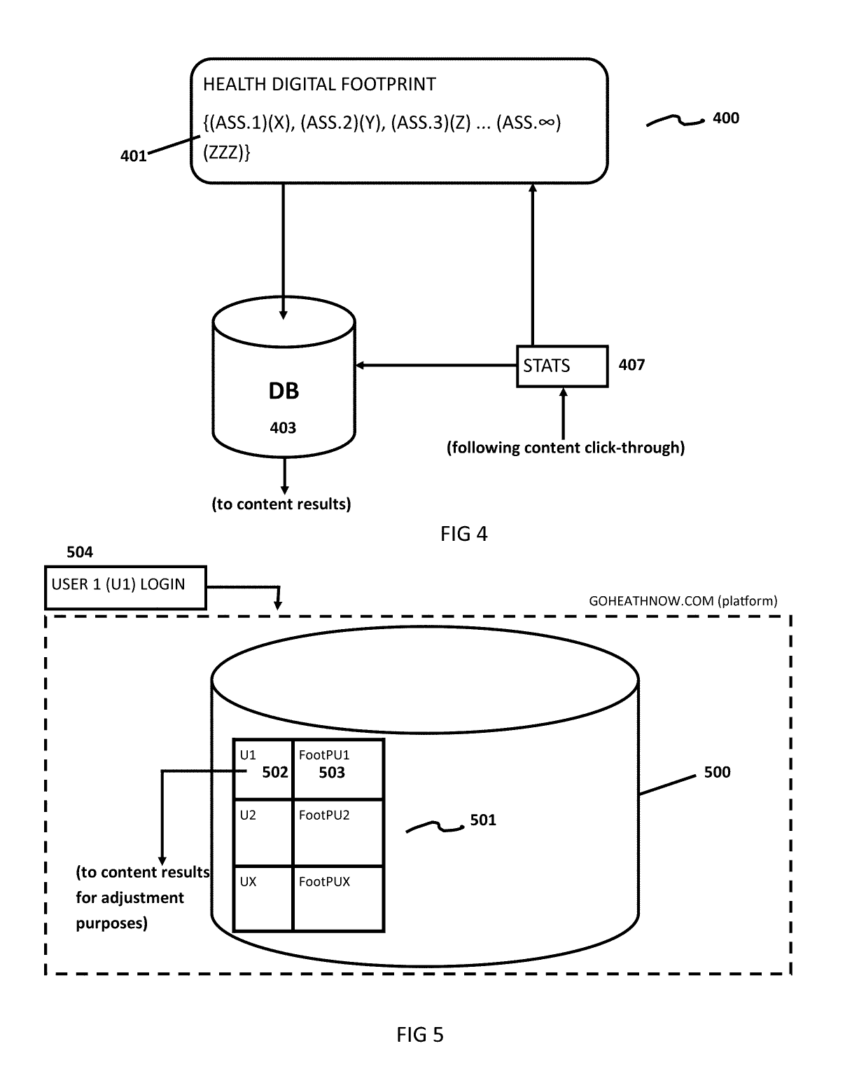

FIG. 4 is an aspect of the system of the present invention.

FIG. 5 is an aspect of the system of the present invention.

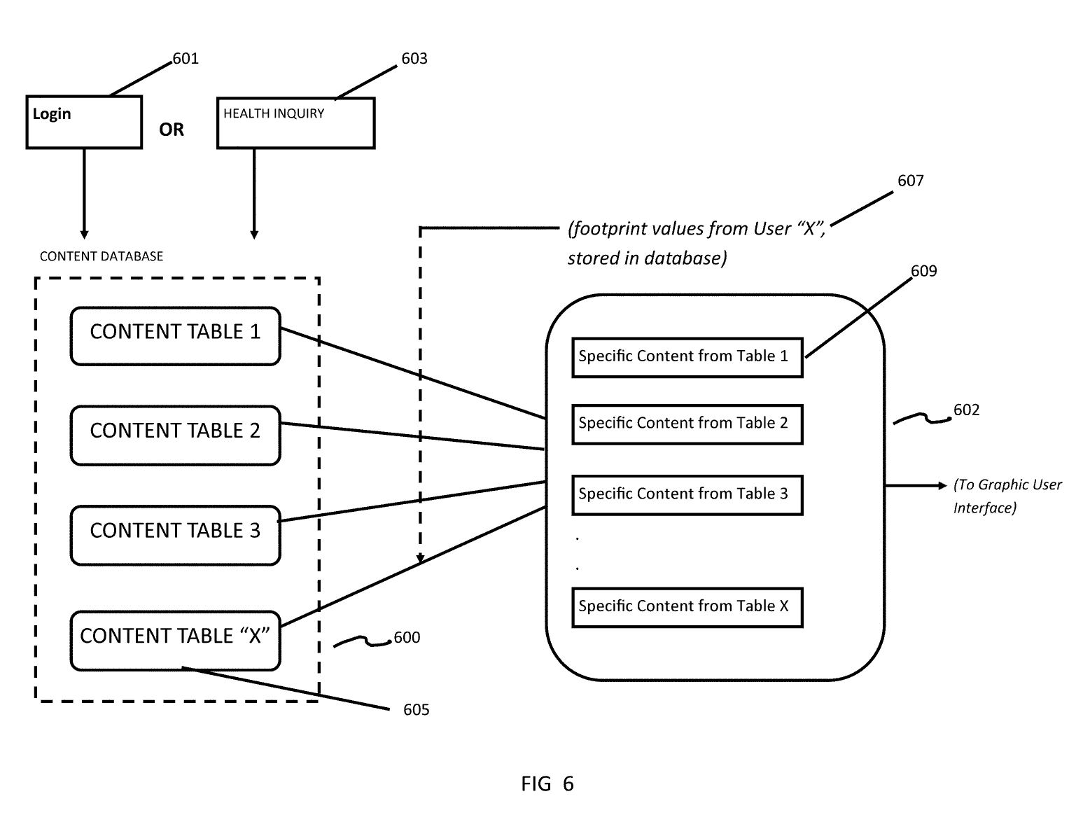

FIG. 6 is an aspect of the system of the present invention.

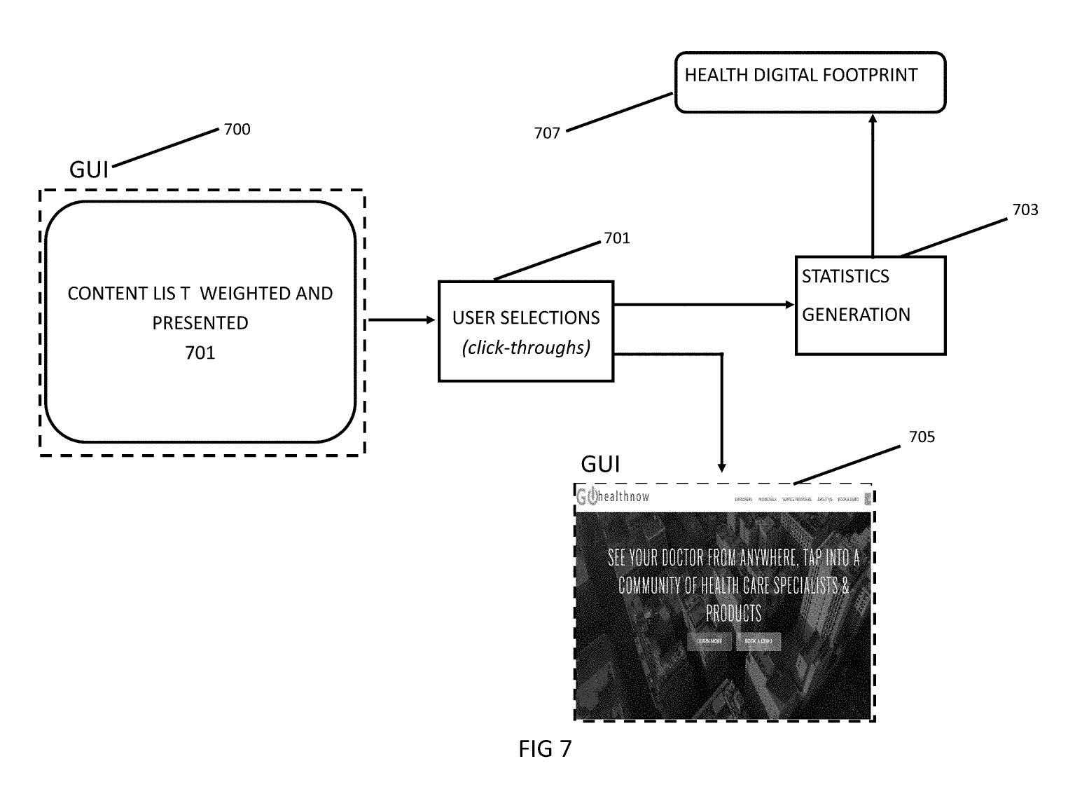

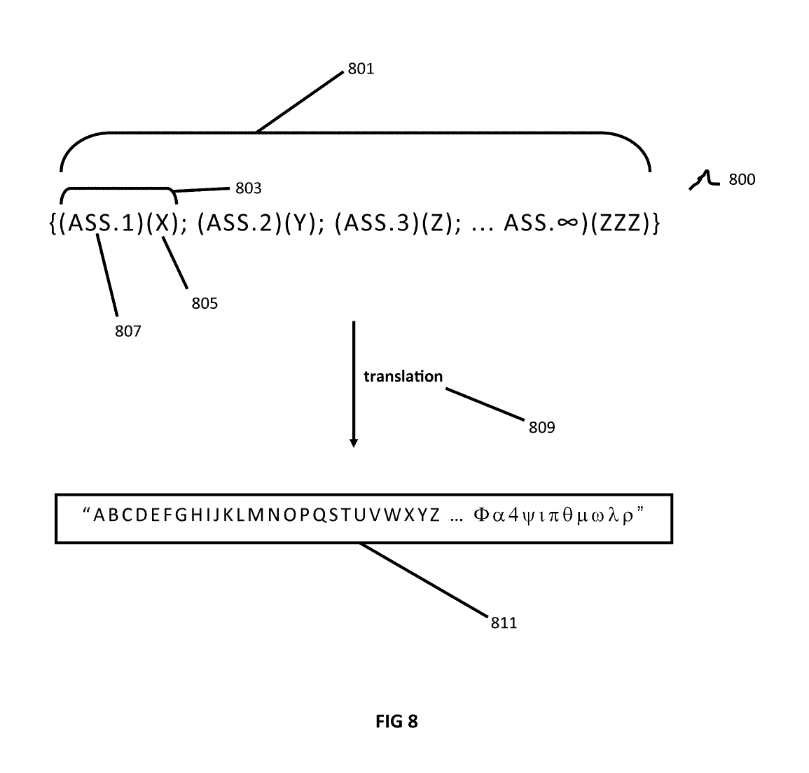

FIG. 7 shows an aspect of the system of the present invention.

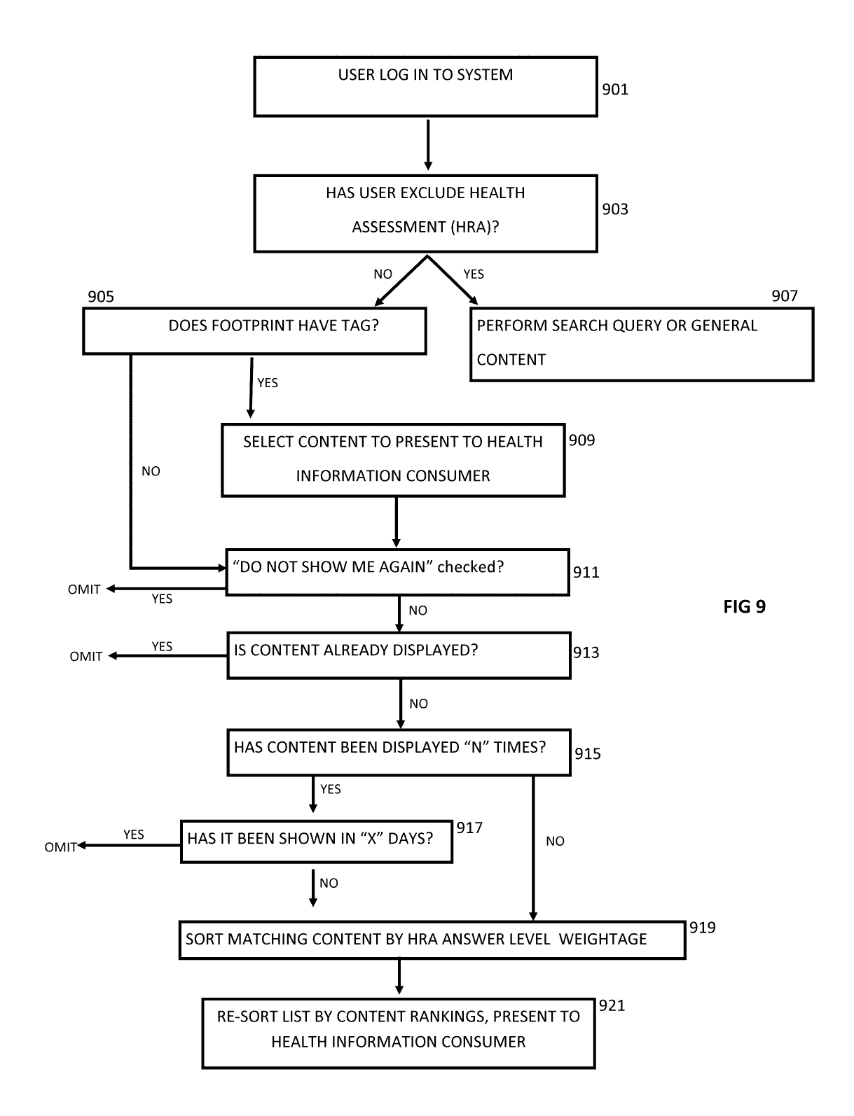

FIG. 8 shows an aspect of the system and method of the present invention.

FIG. 9 is a method of the present invention.

Referring to FIG. 1, a system of the present invention is shown, many aspects to be discussed in further detail below. In accessing the system, which can be by remote access such as through a computer network system like the Internet, a health information consumer can access a health assessment tool (203). The health assessment (203) is stored on the memory of the system of the present invention and presented to a health information consumer on a computer system. The health information consumer can perform and complete different aspects of the health assessment (203) via offline access (202). Offline access (202) can, in one embodiment, include the physiological information or health analysis of the health information consumer. The offline access is discussed in more detail below.

The health assessment (203) present questions or issues to the health information consumer in a variety of categories, including but not limited to demographics which includes age, race, gender, geospatial location, and company of employment, medical analysis which in one embodiment involves data received from offline access (202), emotional health which can include psychological evaluation, exercise evaluation includes number of days of exercise per week, length of exercise per session, frequency of exercise, work information, including type of work, work hours, work days, etc., and direct data from connected devices such as digital wearables. The health assessment (203) is generally a self-health assessment, whereby it is completed by the health information consumer. In one embodiment, the Health Assessment (203) consists of a series of questions, followed by several choices (for example, multiple choice from “a to e”). The various questions are number “1, 2, 3 . . . x”. As previously stated, the health assessment (203) is in digital form. Upon completion of the health assessment (203), a health information consumer digital footprint (i.e., health digital footprint) (205) is generated.

The health digital footprint (205) is a representation of the health assessment (203) in tuple form, for example:

Health Digital Footprint={(ass.1)(x), (ass.2)(y),(ass.3)(z) . . . (ass.∞)(zzz)}

whereby each “ass.” corresponds to an element within the health assessment (203), and “x”, “y”, “z”, till “zzz” corresponds to particular weights given to each element within the footprint tuple. The footprint tuple is further shown and discussed in FIG. 8.

In comparison with the prior art, the health digital footprint improves upon health information consumers ability to locate suitable health-related digital content by increasing consideration of the breadth of factors considered in defining health, increasing considering of the depth of more specific quantitative measurements incorporated, and additive comorbidities i.e., medical diagnosis are considered in addition with other factors, taking into consideration demographic factors, and consideration of biological individuality among different health information consumers.

The digital footprint is self-adjusting in terms of elements and weights based upon changes to the health assessment (205). The generated digital footprint (205) is further adjustable based upon statistical feedback following a health information consumer's interaction with the system of the present invention. The modifications through statistical feedback will be discussed later.

In the method of the present invention, and as will be discussed later, the digital footprint (205) serves as a filter for digital content prior to the content being presented to the health information consumer.

The generated health digital footprint (205) is stored on the memory (207) of the system of the present invention, and organized within a table of health information consumers by references including last name, customer number, email address, login name, and/or password. A specific health digital footprint (205) generated for a health information consumer is further tagged within information for digital content selection, including geospatial location, race, age, gender, and/or employer.

The system of the present invention further includes a health query engine (209), allowing a health information consumer to specify what type of digital content they are in search of.

In another embodiment of the system, whereas a health query engine (209) is present, a health information consumer does not have to use the query engine (209) in order to obtain health information specific to them: the system is setup to automatically present specific health information digital content to a specific health information consumer. The presentation of specific health information digital content to a specific health information consumer occurs because of the health digital footprint (205). As will be further discussed, the health digital footprint (205) drives a query upon a health information consumer accessing the system.

The system further includes various databases and indices (211-217) for the health information digital content. The databases and associated indices contain a variety of categorized health information digital content, including videos, publications, digital images, heath-related products, health-related services, and health-related social media groups. As used in the system and method of the present invention, “videos” refers to electronic medium for the recording, copying and broadcasting of moving visual images, “publications” refers to publicly available documents that generally include text and images, “digital images” refers to digital two-dimensional pictorial representations, “health related products” refers to goods, such as foods, devices, medicines, herbal supplements, exercise implements, and the like directed to improving and or maintaining a human bodily condition, “health related services” refers to physical actions directed toward improving and/or maintaining the human bodily condition, “social media groups” refer to human collaborations involving creating and sharing of information in a computer-mediated environment. The indices of the health information digital content are organized according to health information taxonomy particular to the system and method of the present invention. Through the present invention's taxonomy, specific digital content is both matched to a health query and filter-able by the digital footprint (205).

The taxonomy suitable for the present invention is limited to a specific number of terms, explicitly used for the system of the present invention. All digital content provided for the system and method of using the system falls within the specific taxonomic categories. Example of the taxonomic terms are as follows (Table 1):

TABLE 1
Sample Taxonomic Terms

| | | |
|---|---|---|
| Demographics | Drug Abuse: Social Issues | Exercise: Climbing |
| Dental Problems: | Drug Abuse: Treatment/ | Exercise: Cycling |
| Misc. | Solutions | |
| Fungal Infections | Exercise: Dancing | Heart Mgmt Preven |
| Gallbladder Problems: | ExerciDivingBoard-Platform | HeartAtkSympWrngSignsRisk |
| Misc. | | |
| Gallstones | Exercise: Diving, Skin | Heart Bypass |
| Gardasil | Exercise: Fencing | Heart Failure |
| Gastrointestinal | Exercise: Football | Heart Pacemakers |
| Problems | | |
| Gemzar | Exercise: Gardening | HeartburnGERDIndigestion |
| Gene Therapy | Exercise: Golf | Heat-/Sunstroke |
| Genetic Disorders | Exercise: Gym | Hemophilia |
| GeneticallyAlteredFood | Exercise: Gymnastics | Hemorrhoids |
| Genetics | Exercise: Handball | Hepatitis |
| Geodon | ExercHikingOrBackpacking | Herbal Medicine |
| Glaucoma | Exercise: Hockey, Field | Herceptin |
| Gleevec | Exercise: Hockey, Ice | Hernia |
| Glucophage | Exercise: Home | Heroin |

As shown in FIG. 2, whether driven by a health query (209) or upon logging unto the system, the resulting digital content listing is adjusted by the digital footprint (205), to generate a content list targeted to a specific health information consumer (219).

To be discussed later, the targeted content list (219) is reorganized by a weighting method, such that the content presented to the health information consumer positions the most relevant digital content for that consumer first, and so forth. The weighted content list (221) is delivered to the graphic user interface on the display.

In one embodiment of the present invention, the health related information presented to the health information consumer (via the graphic user display) is URL links represented by either hyperlinks, images with digitally connected hyperlinks, and/or text descriptions with digitally connected hyperlinks. In a preferred embodiment, images with digitally connected hyperlinks are presented to the health information consumer. In a further embodiment, health-related digital content from at least one database index is presented to the health information consumer. In a still preferred embodiment, a health information consumer is presented at least one health related digital content from each of the database indices (videos, publications, images, health-related products, health-related services, and health-related social media groups). In further preferred embodiment, from 3 to 6 health-related digital content items from each of the database indices (videos, publications, images, health-related products, health-related services, and health-related social media groups) are presented to the heath information consumer via a display.

The health information consumer may then engage with the weighted content list (221) by “clicking” on any of the listed digital content titles on the listing (223). Upon clicking, the consumer will be able to gain access to the digital content (information) (227). These content click-throughs also generate statistical information (225), including the type of digital content clicked, the period of time a consumer stayed on or engaged with the digital content, digital content given an approval or high ranking by the consumer, digital content given a negative ranking by the consumer, etc. Examples of micro-statistical information collected for per health information consumer are shown in Table 2. Examples of macro-statistical information collected for the overall users of the system of the present invention are shown in Table 3.

TABLE 2
Micro-statistical Information collected per health information consumer
Statistical information collected per health consumer:

Search
Time on object
Bought
How many times visited on similar object

TABLE 3
Macro-statistical Information collected for all users of the system.
Statistical Information collected for overall users of the present system:

Search
Time on object
Bought
How many times visited on similar object

The statistics (225) is both stored in the memory of the system (207), with it being organized in both a general table for macro-statistical analysis of the all users of the system of the present invention, and micro-statistical analysis for the specific health information consumer whose activities generated the statistics (225).

The statistics (225) are also used to adjust the digital footprint (205), such that the footprint (205) as a filter in future use can better locate digital content for the consumer.

FIG. 3 is an embodiment of an aspect of the system of the present invention, that aspect being the access and completion of the health risk assessment (304), and the generation of a health digital footprint (307).

As shown in FIG. 3, health information consumers (i.e., users) of the present system perform the health assessment report by either an online questionnaire/survey (301), and/or an offline testing station (303).

The online questionnaire/survey (301) poses a series of scenarios, questions, or issues to health information consumers, with the goal of obtaining an objective determination of their health. The various scenarios, questions, or issues focus on issues such as physical health, psychological health, diet, work, health or mental problems, and holistic (mind, body, and soul) considerations.

The offline testing station (303) can determine physiological characteristics of a health information consumer. In one embodiment, the offline testing station (303) is a kiosk-type station wherein a health information consumer can receive a number of different tests, such as strength testing (using weights), measuring vital signs such as respiratory rate, blood pressure, oxygen saturation, and body temperature, organ testing, and other such tests that require direct engagement with the body of a health information consumer. In one embodiment, the offline analysis (303) is automated, whereby a health information consumer engages with a computer-operated testing system (i.e., robotic testing) and applications stored on the testing system. In another embodiment, the offline testing station (303) is used with the assistance of a healthcare professional, such as physicians, dentists, pharmacists, pharmacy technicians, physician assistants, nurses, advanced practice registered nurses, surgeons, surgeon's assistant, athletic trainers, surgical technologist, midwives, dietitians, therapists, psychologists, chiropractors, clinical officers, social workers, phlebotomists, occupational therapists, optometrists, physical therapists, radiographers, radiotherapists, respiratory therapists, audiologists, speech pathologists, operating department practitioners, emergency medical technicians, paramedics, and medical laboratory scientists.

Further, service provider professional include physicians (Internal Medicine, family, OBGYN and other specialists), dentists, physician assistants, nurses, RNs, surgeons, athletic trainers, midwives, dietitians, therapists, acupuncturists, psychologists, psychiatrists, chiropractors, social workers, phlebotomists, occupational therapists, optometrists, physical therapists, addiction counselors, yoga and fitness specialists, family coaches, life coaches, job coaches, art and music therapists, radiographers, radiotherapists, respiratory therapists, audiologists, speech pathologists and other specialists.

The offline testing station (303) can further comprise telecommunication and/or video communication means. With such communication means, a health information consumer can communicate with a healthcare professional, whereby the healthcare professional can be located at a remote distance from the offline testing station (303).

The online questionnaire/survey (301) and the offline testing station (303), in one embodiment, can be located at the same location. In another embodiment, the online questionnaire/survey (301) and the offline testing station (303) are located at remote locations to each other. In the embodiment where the survey (301) and station (303) are at remote distances, both access means (301 and 303) are connected to a computer network system, such as the Internet (not shown). By being connected to a network system, the data collected by the survey (301) and station (303) can be collected by the system for completion of the health assessment report (304).

Regarding completion of the survey (301) and/or station (304), either may be completed first, and then followed by completion of the second.

The health assessment report (304) is, in general, in digital form. The health assessment report (304) collects the issues and responses from the survey (301) and/or station (303). For example, the health assessment report (304) will present the issue or query and the response given by the health information consumer. A query/answer in the report (304) will constitute one item. The health assessment report (304) can be delivered directly to the health information consumer via a digital means, such as electronic mail (email), and/or presented on a computer display.

The health assessment report (304) is stored the memory (305) of the system of the present invention. The health assessment report (304) generates a health digital footprint 307 based on the health assessment report.

The health digital footprint (307) is generally generated from a 1-to-1 relation, i.e., each query/answer item results in an element of the tuple of the footprint (307). In another embodiment, the health digital footprint (307) is generated from a 1-to-many relation, meaning the various query/answer items of the health assessment report (304) are combined and re-combined to create different elements of the footprint tuple (307). The different elements of the footprint tuple (307) represent different characteristics and extrapolations of the health information consumer's data.

In one embodiment, the digital footprint (307) is comprised of a tuple made of from about 50 to 55 health related queries and 2 to 6 demographic to make a total of from 52 to 61 elements. The total number of characters in the tuple is from 280 to 290 characters. In a preferred embodiment, the tuple is made of 53 health related queries plus 4 demographics, to create a total of 57 elements, with a total length of the tuple of 285 characters. As used herein, “demographic” refers to criteria such as education, nationality, religion, ethnicity, economic status and social status.

The generated health digital footprint (307) is stored on the memory (305) of the system.

FIG. 4 is an embodiment of an aspect of the invention, specifically the statistics (407) generated by a health information consumer's use of the system, and the use of the statistics (407) to adjust the individual's health digital footprint (400) and the population's and multiple sub-populations aggregated digital footprint which is (403).

The health digital footprint (400), as previously discussed, is comprised of a tuple (401). In one embodiment, the tuple (401) contains around 300 elements.

As previously stated, the footprint tuple (401) is stored on the memory of the system. Regarding organization, the tuple (401) is organization within a table of the memory in terms of health information consumer surname, consumer customer number, and/or consumer email. Footprint tuples (401) stored within the memory are further tagged by one or several descriptors such as age, race, gender, geospatial location, and/or employer. The use of organization gives a health information consumer the ability to login in the system and access her footprint tuple (401). The use of descriptors allows the system of the present invention to filter content available on the system such that what is presented the health information consumer is specific to the health information consumer.

FIG. 5 is an embodiment of an aspect of the present invention, whereby the table of footprint tuples (501) are stored on the memory (500). As shown, the multitudes of health information consumers, for example (502), are organized within the table. Upon a health information consumer, for example User 1 (504), logging onto the system the footprint tuple pertinent to that user (504), for example (503), is utilized to either filter a search query posed by the user, or filter digital content that is auto-delivered to the display of the user (504). Upon receiving statistics relating to a health information consumer's use of the system, the statistics adjusted the digital footprint tuple (503) such that future queries will be more exact for the user (504) than the previous query.

FIG. 6 is an embodiment of an aspect of the present invention, whereby the means of obtaining digital health information content through the present invention is shown. As shown, upon either logging in to the present system (601), or logging in and presenting a health query (603), the database (600) containing the digital content indices (605) of the system are accessed. The database indices (605) can number from 1 to any number, and can be categorized in terms of videos, articles, social media groups, images, healthcare service providers, and healthcare-related products. In use, all indices (605) are accessed, and the digital content is then filtered by the footprint tuple (607) for a specific health information consumer. The filtered content from each indices (609) is then selected, collated, and delivered to a graphic user interface for accessing by the specific health information consumer.

FIG. 7 is an aspect of the system of the present invention, whereby on a graphic user interface (700), for example a display of a computer system, the listing of digital content geared to the health information consumer is weighted (re-sorted) and presented (701) to the health information consumer. The health information consumer (user) is then able to select digital content by “clicking” on specific URLs (702). The URL (702) click through then presents the digital content on the display (705). The URL click-through results in the generation of statistical data (703), as previously discussed. The generated statistical data (703) results in modification of health digital footprint (707).

FIG. 8 is an embodiment of the footprint (800) created by the system and method of the present invention. The footprint (800) is made of a tuple (801) composed of elements (803), wherein the elements (803) are made from health queries and demographic queries (807) and associated weight factors (805). The tuple (801) is resultant from the health-related assessment, as discussed previously.

Examples of the associated weight factors (805) used in the tuple (801) is shown in Table 4.

TABLE 4
Weight Factors used in the Digital Footprint

| | Range | Preferred Weight |
|---|---|---|
| Demographic assessment: | 1.0-1.5 | 1.26 |
| Medical assessment: | 0.9-1.25 | 1.14 |
| Emotional Health assessment | 0.80-1.0 | 0.93 |
| Exercise assessment | 0.6-0.9 | 0.87 |
| Work assessment | 0.6-0.8 | 0.71 |
| Other assessment | 0.3-0.65 | 0.56 |

The tuple 81 is further subjected to a translation (809) of the present invention, whereby the translation converts the tuple (801) into a multi-character string (811). The multi-character string (811) is used as the means for filtering health related digital content which is presented to the health information consumer.

For example, the multi-character string (811) is compared to a “dictionary” whereby each string equals to terms within the taxonomic engine of the present invention.
“BCD”=“Exercise: Yoga”
“PQS”=“Cramps: Muscle”
   etc.

FIG. 9 is an embodiment of the method of the present invention, whereby a health information consumer logs onto the system in order to obtain health information digital content specific to their needs.

As shown in FIG. 9, the health information consumer (user) logs onto the system (901). A determination is then made by the system as to whether or not the user has excluded, or did not perform the health assessment for consideration by the system (903). In such a scenario, a user may elect to exclude the health assessment in order to “open up” access to all the digital content of the system. In the event the user has elected to exclude the health assessment, the user may perform a straight search query or receive general, arbitrary digital content to their display (907).

In the event the health assessment has not been excluded, a determination is made as to the tagging associated with the digital footprint (905). If the digital footprint does have tagging, specific digital content for the health information consumer will be delivered to the display (909).

A filtering determination is then made as to whether specific digital content has been checked for “Do Not Show Me Again” status (911). “Do Not Show Me Again” status means the user elected to not see specific digital content again. For digital content that has “Do Not Show Me Again” status, this digital content is excluded from the users display.

Another filtering determination is made as to whether content has already been displayed (913). If it has been displayed, it is omitted from the user's display. If not, the number of times the digital content has been displayed is measured. If the number of times of content display reaches a pre-determined threshold, for example 3, or 5 times, a further determination is made as to how many days since the last time it was shown.

If the number of days since the content has been shown falls below a pre-determined threshold (915), for example “the content was shown within the last 2 days”, and the pre-determined threshold for days is set to 5, the content will be omitted from the display of the user.

If the content is not omitted for one of the previous reasons, the digital content will be sorted according the original health assessment answer level weightage (919). The digital content is then re-sorted by content rankings, and then presented to the user (921).

### EXAMPLE

Health information consumer “A” completes a digital health assessment, whereby the health assessment consists of 50 queries focused on health-related issues and demographic data. The health assessment is transformed into a health digital footprint in the form of

Digital Footprint of Health information consumer “A”={001.4(1.26):003.5(0.93):036.9(0.56) . . . et seq.}

where 001.4 is ass. 1; 003.5 is ass.2; 036.9 is ass.3,
and 1.26, 0.93, and 0.56 are weight factors for the various assessments (ass.).

Upon generation of the digital footprint, consumer “A” may then perform a health query against the various database indices of the system and then visit the user interface display, or elect to visit the user interface display of the system directly. After being taken to the user interface display, the user will be presented with images hyperlinked to health care digital content. The user interface display shows 3 images per database index, whereby the database accessed include videos, publications, images, products, services, and social media groups.

The health information consumer may interact with any or all of the presented digital content items. Upon interacting, statistics are generated and delivered the digital footprint engine and memory. The statistics are used to adjust the digital footprint of “A”, such that future digital content will reflect User “A”'s previous interactions. The statistics are also used to modify the system overall based on macro-statistics, meaning that User “A”'s interactions with the system will be compared and coupled with other user's interactions. Future users who match certain aspects of User “A” will be presented with digital content item along similar characteristics to that shown to User “A”.

After a predetermined period of time, specific digital content shown to User “A” will be reset.

We claim:

1. A system for presenting health-related digital content to a health information consumer, comprising:
computer interface having a processor, at least one user interface, and a memory;
a digital health assessment stored on said memory, said digital health assessment containing at least one digital query and at least one selection of answers for said digital query;
a health digital footprint generated from said digital health assessment, wherein said health digital footprint includes a tuple, wherein said tuple is created from elements multiplied by at least one weight factor, wherein said elements are derived from said digital query and one answer selected from said selection of answers;
at least one database index stored on said memory, wherein said database index is accessed by said digital footprint;
at least one hyperlink digitally stored on said database index, wherein said hyperlink is digitally connected to a health-related digital content item stored on said memory;
a keyword taxonomic list stored on said memory, wherein said keyword taxonomic list is activated by said digital footprint to locate said hyperlink;
at least one statistical data generated from a user interacting with said hyperlink; and
a feedback loop of the at least one statistical data into said health digital footprint to provide an adjusted thereto and into said memory to adjust a future presentation of health-related digital content.

2. The system for presenting health-related digital content to a health information consumer of claim 1, wherein said computer interface comprises a display as a user interface.

3. The system for presenting health-related digital content to a health information consumer of claim 1, wherein said digital health assessment comprises from between 50 to 55 health-related queries, 2 to 6 demographic queries, and a selection of answer for each health-related query and each demographic query.

4. The system for presenting health-related digital content to a health information consumer of claim 3, wherein said elements in said health digital footprint are generated from a concatenation of each of said heath-related query or said demographic query, and an answer selected from each of said selection of answers.

5. The system for presenting health-related digital content to a health information consumer of claim 1, wherein said weight factor is selected from the range consisting of 1.0-1.5, 0.9-1.25, 0.80-1.0, 0.6-0.9, 0.6-0.8, and 0.3-0.65.

6. The system for presenting health-related digital content to a health information consumer of claim 5, wherein said weight factor is selected from 1.26, 1.14, 0.93, 0.87, 0.71, and 0.56.

7. The system for presenting health-related digital content to a health information consumer of claim 4, wherein said elements each have a weight associated thereto.

8. The system for presenting health-related digital content to a health information consumer of claim 1, wherein said hyperlink is presented as a digital image.

9. The system for presenting health-related digital content to a health information consumer of claim 1, wherein said statistical data is selected from the group consisting of search keyword, time on object, item bought, and how many times visited on a similar object.

10. The system for presenting health-related digital content to a health information consumer of claim 9, further comprising one or more additional statistical data selected from the group consisting of search keyword, time on object, item bought, and how many times visited on similar object.

11. A method of presenting health-related digital content to a health information consumer, comprising the steps of:
completing a digital health assessment stored on a memory;
generating a health digital footprint from said health assessment;
activating a keyword taxonomic list by said digital footprint
accessing at least one database index by said digital footprint via said keyword taxonomic list;
presenting at least one hyperlink related to a digital content item from said database index;
interacting with said hyperlink;
generating at least one statistical data following interacting with said hyperlink;
delivering said statistical data to said health digital footprint and a memory; and
adjusting said health digital footprint by said statistical data.

12. The method of presenting health-related digital content to a health information consumer in claim 11, wherein completing said digital health assessment comprises providing an answer to at least one health-related query and/or at least one demographic query.

13. The method of presenting health-related digital content to a health information consumer in claim 12, wherein completing a digital health assessment comprises providing one answer to each of 50 to 55 heath related queries and each of 2 to 6 demographic queries.

14. The method of presenting health-related digital content to a health information consumer in claim 13, wherein generating a health digital footprint comprises generating an element from each of said health related query and associated query answer, and each of said demographic query and associated query answer, and multiplying each query and answer by a weight factor.

15. The method of presenting health-related digital content to a health information consumer in claim 14, wherein multiplying each query and answer by a weight factor comprise selecting a weight factor from the group consisting of 1.0-1.5, 0.9-1.25, 0.80-1.0, 0.6-0.9, 0.6-0.8, and 0.3-0.65 for each element.

16. The method of presenting health-related digital content to a health information consumer in claim 11, further comprising the step of tagging each of said health digital footprint with one or more tags.

17. The method of presenting health-related digital content to a health information consumer in claim 11, further comprising accessing one or more additional database indices selected from the group consisting of video, publications, social media groups, products, and services.

18. The method of presenting health-related digital content to a health information consumer in claim 11, wherein presenting at least one hyperlink related to a digital content item comprises presenting a hyperlink digitally connected to a digital image.

19. A method of presenting health-related digital content to a health information consumer, comprising the steps of:
completing a digital health assessment stored on a memory including the steps of completing each of 50 to 55 health related queries and each of 2 to 6 demographic queries by selecting an answer for each query;
generating a health digital footprint from said digital health assessment including the step of generating an element from each of the health related queries and demographic queries and associated answers, and further multiplying said element by a weight factor selected from the group consisting of 1.26, 1.14, 0.93, 0.87,0.71, and 0.56;
activating a keyword taxonomic list by the digital footprint;
accessing databases indices including a video database index, a publication database index, a social media database index, a product database index, and a service database index;
presenting from one to three hyperlinked images from said database indices on a user interface display;
interacting with the hyperlinked images by clicking on the images;
generating statistical data based on interacting with the hyperlinked images;
delivering the statistical data to the health digital footprint and a memory;
adjusting the health digital footprint by the statistical data; and
presenting new digital content items to a user interface display based on the adjusted health digital footprint.
